(19) United States
(12) Patent Application Publication
(10) Pub. No.: US 2007/0048592 A1
(43) Pub. Date: Mar. 1, 2007

(54) Composition, complex and method for enhancing catalysts utilization

(75) Inventors: Fu-Chi Wu, Tucheng (TW); Li-Duan Tsai, Hsinchu (TW); Kan-Lin Hsueh, Hsinchu (TW); Du-Yuan Yu, Bade (TW); Chiou-Ping Huang, Hsinchu (TW); Sung-Chun Chang, Taipei (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsinchu Hsien (TW)

(21) Appl. No.: 11/429,108

(22) Filed: May 8, 2006

(30) Foreign Application Priority Data
Aug. 29, 2005 (TW) 94129459

(51) Int. Cl. H01M 4/86; H01M 4/92; H01M 4/96; H01M 4/88; B01J 31/00; B01J 21/18

(52) U.S. Cl. 429/42; 429/44; 502/101; 502/150; 502/180

(57) ABSTRACT

The present invention relates to a composition for enhancing the utilization of catalysts in fuel cell, comprising catalysts, proton-exchanged ionic polymers, and coupling agents. The coupling agents are bonded to the catalysts or catalyst carriers by a B1 functional group and bonded to the proton-exchanged ionic polymers by a B2 functional group. The present invention also relates to a method for enhancing the utilization of catalysts in fuel cell, comprising the steps of (a) utrasonicating catalysts; (b) adding coupling agents to bond to the catalysts; (c) adding a perfluoro polymer to form a catalyst-coupling agent-perfluoro polymer complex whereby developing stable dispersion; wherein the coupling agents in step (b) are bonded to the catalysts by a B1 functional group and bonded to a perfluoro polymer by a B2 functional group. The present invention also provides a complex for enhancing the utilization of catalysts in fuel cell, comprising catalysts, coupling agents, and proton-exchanged ionic polymers, wherein the coupling agents are bonded to the catalysts by a B1 functional group and bonded to the perfluoro polymer by a B2 functional group to form a complex.

### FIELD OF THE INVENTION

The present invention relates to a composition and method for enhancing the utilization of catalysts in polymer electrolyte fuel cells, more particularly to the formation of a complex by adding a coupling agent for linking catalyst particles and proton-exchanged ionic polymer, and make the polymer has the function of stabilizing agent to maintain the dispersion as well as improve protonic conductivity in the electrode, thereby enhancing the utilization of catalysts in polymer electrolyte fuel cells.

### BACKGROUND OF THE INVENTION

Polymer electrolyte fuel cells (PEFCs) are characterized by high conversion efficiency, no emission, and easy of quick refueling and are thus one of the most feasible ways to solve energy problems and environmental protection problems in the future. The Direct methanol fuel cell (DMFC) that is formed by directly adding methanol as a fuel has a potential in the applications of portable electronic products.

In the existing development of fuel cell technology, the noble metal, platinum (Pt), is the most suitable catalyst, but it is the only material that cannot be synthesized by artificial means. Therefore, Pt is predicted to be the key factor affecting the costs for mass production. The reason of failing to complete the commercialization of fuel cells rests on their practicality and cost. Among them, the low catalyst utilization is one of the main reasons. With the price reduction in membranes by the invention of new membranes, the main factor is considered for the commercialization of fuel cells in the future is the way to enhance the utilization of catalysts to reduce the amount of catalysts used.

As the rate of electrochemical reactions of fuel and oxygen in fuel cells is rather low, an anode catalyst and a cathode catalyst are required to speed up the reactions. Taking the PEFC as an example, a basic membrane electrode assembly (MEA) is comprised of five layers, including a proton exchange membrane (PEM) to diffuse protons placed between an anode catalyst layer and a cathode catalyst layer on the two sides of each electrode, with a fuel micro-porous layer (MPL) and an oxygen gas diffusion layer (GDL) on the outermost layer of each electrode. The structure of the catalyst layers is more complicated and major electrochemical changes are generated there.

According to a schematic view of the reaction of a DMFC as shown in FIG. 1, an effective catalyst requires not only sufficient active sites, but also smoothly mass transport routes for proton, electron, reactants, and products, thereby chemical energy can be successfully converted into electrical energy. If the design and fabrication of the catalyst layer is not good, smooth proton exchange is not possible. In this way, high current is unable to be generated, and efficiency becomes lower. The catalyst layers are placed between the PEM and the GDL (or MPL), and fabricated by first evenly mixing a moderate amount of catalysts with PFSI solution. This mixture is called a catalyst paste, which can be pasted on the GDL (or MPL) or the PEM.

Pt-based nano-particles, proton-exchanged ionic polymer, for example perfluorosulfonic ionomer (PFSI) or Nafion®, and solvents are three main components of a conventional catalyst paste for PEFCs. The primary particle sizes of catalysts are around 2 to 5 nm. Normally, the solid content of the catalyst paste is usually around 20 to 40 wt. %. That means large catalyst surface exists and needs to be stabilized. The addition of PFSI has two functions. Firstly, it provides proton-conducting sites. Secondly, PFSI serves as binder to fix catalyst particles on the catalyst layer. The control of the dispersion of catalyst paste to enhance catalyst utilization is the key to the competitiveness of fuel cells in the market in the future. However, it is difficult to maintain dispersion stability between chemically dissimilar Pt nano-particle and PFSI. In addition, the surface potential of the Pt nano-particle is negative and the PFSI also carries negative charges after dissociation. Therefore, the affinity between catalysts and PFSI is greatly reduced due to the repulsion of electric charges, thereby resulting in aggregation of Pt nano-particles and PFSI individually. Moreover, to enhance dispersion of catalyst paste can enlarge active surface, the mass transport problem is also needed to be considered in particular in the dense catalyst layer.

In order to achieve even dispersion, on the one hand, it is necessary to avoid the mutual aggregation of catalysts, which reduces the surface area. Therefore, catalysts are required to be dispersed as much as possible, thereby greatly increasing the exposed active surface of catalysts; on the other hand, it is necessary to make the PFSIs close to the catalyst particles as much as possible, thereby facilitating the proton exchange and further enhancing the utilization of catalysts. Past studies on the preparation of catalyst pastes only considered the following factors: energy dispersion, adjustment of solvent types and viscosity, adjustment of solubility between polymers and solvents, or the use of surfactants (stabilizing agents), without considering the issues encountered by the absorption between PFSIs and catalyst particles including: (1) catalyst particles easily expel the PFSIs due to the aggregation; (2) phase separation and cracking occurs during the coating/drying process. As the basic solution is to overcome the problem of the absorption of polymers and catalysts, it is worth studying the acting forces between PFSIs and catalyst particles to solve the problem of low-utilization of catalysts.

### SUMMARY OF THE INVENTION

After thoroughly analyzing the dispersion of paste from the fundamental theories, we found the simplest way to improve the dispersion and subsequent catalyst utilization is using proton-exchanged ionic polymer itself as the stabilizing agent instead of adding any other agent. So that larger active surface and higher protonic conductivity can be achieved and consequently lead to high catalyst utilization. To increase the affinity between chemically dissimilar Pt particle and PFSI, it is the primary object of the present invention to provide a catalyst-coupling agent-perfluoro polymer complex by adding a coupling agent to a catalyst paste, thereby enhancing the dispersion and protonic conductivity, overcoming the drawbacks of individual aggregation of the polymers and the catalysts in the conventional catalyst pastes, and enhancing the utilization of catalysts.

Another object of the present invention is to provide a composition for enhancing the utilization of catalysts in fuel cells, by adding a coupling agent to a conventional catalyst paste to form a complex of catalyst-coupling agent-perfluoro polymer in the paste, thereby stabilizing dispersion in the catalyst paste and enhancing the utilization of catalysts.

Another object of the present invention is to provide a method for enhancing the utilization of catalysts in fuel cells in order to enhance the dispersion and absorption between catalysts and PFSIs in the catalyst paste, thereby facilitating the subsequent MEA fabrication process. To achieve the aforementioned objects, the present invention provides a complex for enhancing the utilization of catalysts in fuel cells, comprising catalysts, coupling agents, and proton-exchanged ionic polymers (for example, PFSI), wherein the coupling agents are bonded to the catalysts by a B1 functional group and bonded to the proton-exchanged ionic polymers by a B2 functional group in order to form a complex.

According to a preferred embodiment, the B1 functional group includes the silyl group, the silane group, the carbonate group, the phosphate group, or the borate group, whereas the B2 functional group is the epoxy group or the amino group, wherein the bonding method can be a covalent bonding or a non-covalent bonding. The coupling agent is preferably 3-glycidoxypropyl trimethoxysilane (GPTMS) or 3-aminopropyl trimethoxysilane (APTMS). The catalyst is a transition metal or other compounds, preferably PtRu or Pt. The proton-exchanged ionic polymer is a perfluoro polymer, preferably PFSI or Nafion®.

The present invention provides a composition for enhancing the utilization of catalysts in fuel cells, comprising catalysts, proton-exchanged ionic polymers, and coupling agents, wherein the weight ratio of the catalysts to the proton-exchanged ionic polymers is 0.1-100, and the weight ratio of the catalysts to the coupling agents is 10-1000; wherein the coupling agents are bonded to the catalysts by a B1 functional group and bonded to the proton-exchanged ionic polymers by a B2 functional group in order to form a complex.

In another preferred embodiment of the present invention, the B1 functional group includes the silyl group, the silane group, the carbonate group, the phosphate group, or the borate group, whereas the B2 functional group is the epoxy group or the amino group. A coupling agent is preferably 3-glycidoxypropyl trimethoxysilane (GPTMS) or 3-aminopropyl trimethoxysilane (APTMS). The catalyst is a transition metal or compounds thereof, preferably PtRu or Pt. The proton-exchanged ionic polymer is a perfluoro polymer, preferably PSFI or Nafion®. The bonding method can be a covalent bonding or a non-covalent bonding.

In another preferred embodiment of the present invention, the catalysts can further be deposited to a catalyst support, which is then bonded to the proton-exchanged ionic polymers, wherein the catalyst carrier includes carbon, titanium, gold, silver, or copper. In another preferred embodiment of the present invention, the weight ratio of the catalysts to the coupling agents is 10-200, preferably 50. The weight ratio of the catalysts to the proton-exchanged ionic polymers is 1-20, preferably 4. It should be noted that the composition is only a part of the catalyst paste. Therefore, the ratio of the composition is not limited by the ratio of other substances in the catalyst paste.

In another preferred embodiment of the present invention, the composition of the present invention further comprises a solvent, for example, n-butyl acetate (nBA), ethylene glycol (EG), or glycerol.

The present invention provides a method for enhancing the utilization of catalysts in fuel cells, comprising the steps of: (a) utrasonicating catalysts in solvent; (b) adding coupling agents to bond to the catalysts; and (c) adding a perfluoro polymer to the coupling agents to form a catalyst-coupling agent-perfluoro polymer complex whereby developing stable dispersion, wherein the coupling agents are bonded to the catalysts by a B1 functional group and bonded to the perfluoro polymer by a B2 functional group.

In another preferred embodiment of the present invention, the catalysts of step (b) are bonded to the coupling agents from the hydroxyl (OH) group on a surface thereof, such that the method of carrying the OH group on the catalyst surface can further add an oxidizing agent to oxidize the catalyst surface or pass steam to the catalysts before step (b); oxidize the catalyst surface by hydrogen peroxide; or place the catalyst in the air to be naturally oxidized and form OH; or any other method that can achieve the same effect.

In the method of the present invention, the B1 functional group includes the silyl group, the silane group, the carbonate group, the phosphate group, or the borate group, whereas the B2 functional group is the epoxy group or the amino group, wherein the bonding method can be a covalent bonding or a non-covalent bonding.

The catalysts of step (a) are transition metals or other compounds, preferably PtRu or Pt and can further be bonded to a catalyst carrier such as carbon, gold, silver, copper or titanium. The catalyst carrier is also can be bonded to a proton-exchanged ionic polymer. The coupling agent of step (b) is 3-glycidoxypropyl trimethoxysilane (GPTMS) or 3-aminopropyl trimethoxysilane (APTMS). The perfluoro polymer of step (c) is PSFI or Nafion®.

In another preferred embodiment of the present invention, the present invention provides a method wherein the weight ratio of the catalysts to the coupling agents is 10-1000, more preferable is 10-200 and most preferable is 50. The weight ratio of the catalysts to the proton-exchanged ionic polymers is 0.1-100, preferable is 1-20 and most preferable is 4.

### BRIEF DESCRIPTION OF THE DRAWINGS

The above objects and advantages of the present invention will become more apparent with reference to the appended drawings wherein:

FIG. 1 is a schematic view of the reaction of an anode and a cathode of a DMFC.

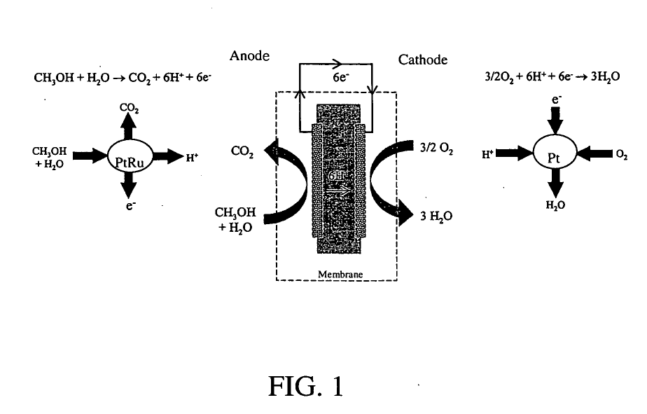

FIG. 2 is a schematic view showing the enhancement of the utilization of catalysts in fuel cell by the composition of the present invention.

FIG. 3 is a schematic view showing the even dispersion of catalysts in catalyst paste or in catalyst layer by the composition of the present invention.

FIG. 4 is a flowchart of electrode fabrication according to an embodiment of the present invention.

FIG. 5 shows the distribution of particulate sizes of the catalyst paste according to DLS of the present invention.

FIG. 6 shows the cyclic voltammogram of a half-cell according to the present invention.

FIG. 7 shows the relationship of voltage-current density (V-I) and power-current density (P-I) of the catalyst paste according to the present invention and a conventional catalyst paste.

### DETAILED DESCRIPTION OF THE INVENTION

The present invention provides a complex for enhancing the utilization of catalysts in fuel cells, comprising catalysts, coupling agents, and proton-exchanged ionic polymers. Referring to the following drawing for the bonding relationship of the catalysts, the coupling agents, and the proton-exchanged ionic polymers as an embodiment of the present invention, part B in the drawing refers to a coupling agent, wherein the coupling agent is bonded to the catalyst as shown as part A by a B1 functional group, and bonded to a proton-exchanged ionic polymer as shown as part C (for example, perfluoro polymer or Nafion®) by a B2 functional group. The catalyst can be PtRu, Pt, or other substances capable of catalyzing activity. In another embodiment of the present invention, the catalyst can further be bonded to a catalyst carrier, which includes carbon, titanium, gold, silver, or copper.

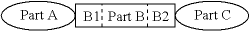

The catalyst-coupling agent-proton exchange ionic polymer complex of the present invention forms stable spatial repulsion to overcome the problem of reduced reaction surface area caused by the aggregation of catalyst particles. Moreover, the formation of the complex of the present invention can avoid the mutual absorption and aggregation of the polymers, which causes an inability to unevenly cover the catalyst. No matter whether the catalyst paste is settled down and aggregated in the subsequent fabrication process (for example, coating, drying, and thermal compression), the reaction can still proceed because the proton-exchanged ionic polymer has been fixed on the catalyst surface. Therefore, the catalyst-coupling agent-proton exchange ionic polymer complex of the present invention can disperse the catalyst as much as possible and increase the exposed active surface area of the catalyst; moreover, this can make the polymer cover on the catalyst surface, thereby facilitating proton exchange and enhancing the utilization of catalysts.

Moreover, the present invention provides a composition for enhancing the utilization of catalysts in fuel cells, comprising catalysts, proton-exchanged ionic polymers, and coupling agents. The weight ratio of the catalysts to the coupling agents is 10-1000, more preferably 10-200 and most preferably 50. The weight ratio of the catalysts to the proton-exchanged ionic polymers is 0.1-100, more preferably 1-20 and most preferably 4. The catalysts, the proton-exchanged ionic polymers, and the coupling agents can form a complex, with a structure as described in the above.

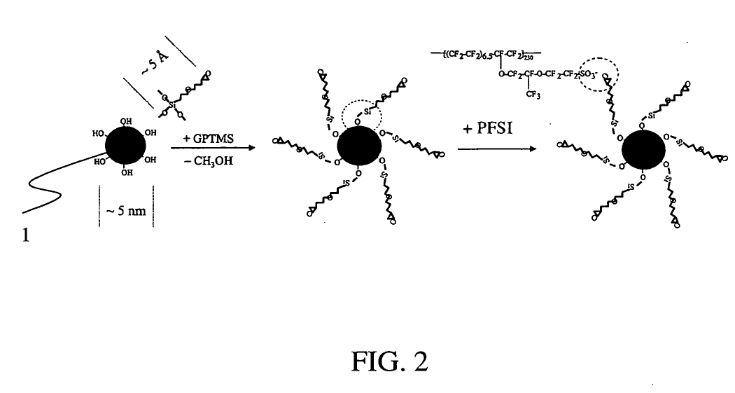

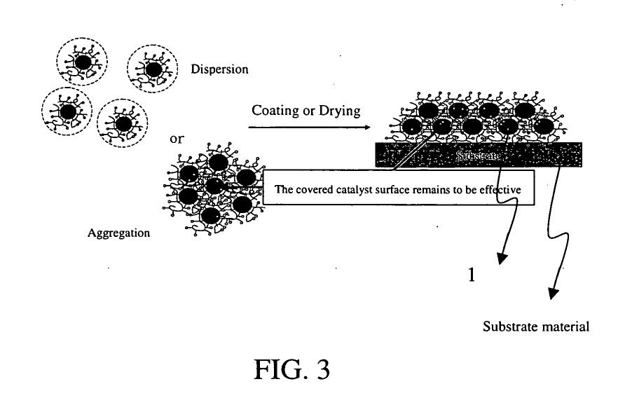

The present invention provides a method for enhancing the utilization of catalysts in fuel cells. Referring to FIG. 2, OH is formed on a surface of a catalyst 1 evenly by passing steam or oxygen, or being treated with hydrogen peroxide, or even being placed in the air to make OH naturally be formed. Then a coupling agent such as APTMS or GPTMS is added to proceed with alcohol condensation and form bonding. Finally, PFSI is added and bonded to a coupling agent to form a catalyst-coupling agent-perfluoro polymer complex. Referring to FIG. 3, the complex forms spatial repulsion to avoid the aggregation of particles of the catalyst 1. Moreover, no matter whether the catalyst particles are dispersed or aggregated during a long time, the catalyst 1 can be fully utilized in fuel cell. Moreover, the method of the present invention can form a stably dispersed complex, which can thus become evenly coated on the gas diffusion layer or the proton exchange membrane. Contrary to the conventional catalyst pate coating technology, the method of the present invention has the advantage of having catalyst dispersion not affected by coating or drying.

It is to be understood that the following examples of the present invention should not be based to restrict the invention, and that all equivalent modifications and variations made without departing from the intent and import of the following descriptions of the examples should be included in the following claims.

### EXAMPLES

### Example 1

### Electrode Fabrication According to the Method of the Present Invention

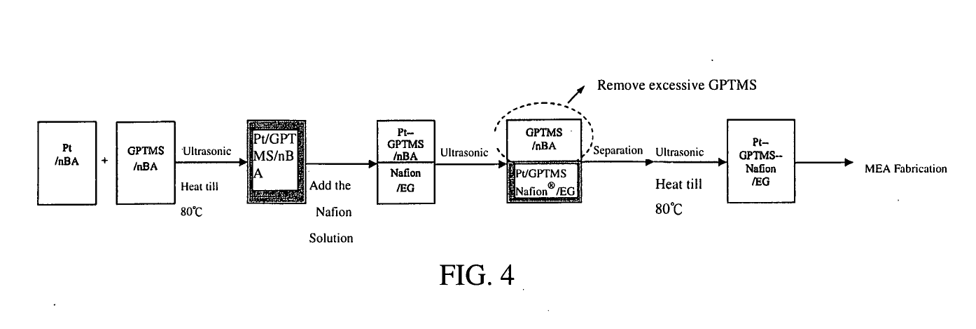

Referring to FIG. 4 for a flowchart of electrode fabrication according to the method for enhancing the utilization of catalysts in fuel cells, Pt and the coupling agent, GPTMS, are dispersed by ultrasonic in nBA to form Pt/nBA and GPTMS/nBA. Then mix Pt/nBA and GPTMS/nBA in the ratio of Pt:GPTMS=100:2, place the mixture in a 80° C. water bath for 3 minuets, and have it utrasonicated. Nafion® PFSI solution and EG were mixed and heated to remove water and alcohol and form Nafion®/EG Add Nafion®/EG to the previous mixture in the ratio of Pt: Nafion®=4:1 and make the reacted Pt-GPTMS/EG settle in the lower EG by ultrasonic waves, whereas the un-reacted GPTMS was remained in the upper layer solution. After separating the excessive GPTMS, place the Pt-GPTMS/EG in a 80° C. water bath, and have it utrasonicated to obtain a product, Pt-GPTMS-Nafion®/EG Finally, the product undergoes electrode fabrication and the fabricated electrode is further fabricated into a membrane-electrode assembly (MEA).

### Example 2

### Electrode Fabrication According to the Method of the Present Invention

Pt and the coupling agent, APTMS, are dispersed by ultrasonic in nBA to form Pt/nBA and APTMS/nBA. Then mix Pt/nBA and APTMS/nBA in the ratio of Pt:APTMS=100:2, place the mixture in a 80° C. water bath for 3 minuets, and have it utrasonicated. Nafion® PFSI solution and EG were mixed and heated to remove water and alcohol and form Nafion®/EG Add Nafion®/EG to the previous mixture in the ratio of Pt: Nafion®=4:1 and make the reacted Pt-APTMS/EG settle in the lower EG by ultrasonic waves, whereas the un-reacted APTMS was remained in the upper layer solution. After separating the excessive APTMS, place the Pt-APTMS/EG in a 80° C. water bath, and have it utrasonicated to obtain a product, Pt-APTMS-Nafion®/EG Finally, the product undergoes electrode fabrication and the fabricated electrode is further fabricated into a membrane-electrode assembly (MEA).

### Example 3

### DLS Test of the Catalyst Paste

Examining the composition fabricated in Example 1 with Dynamic Light Scattering (DLS) for testing the particulate size of the paste.

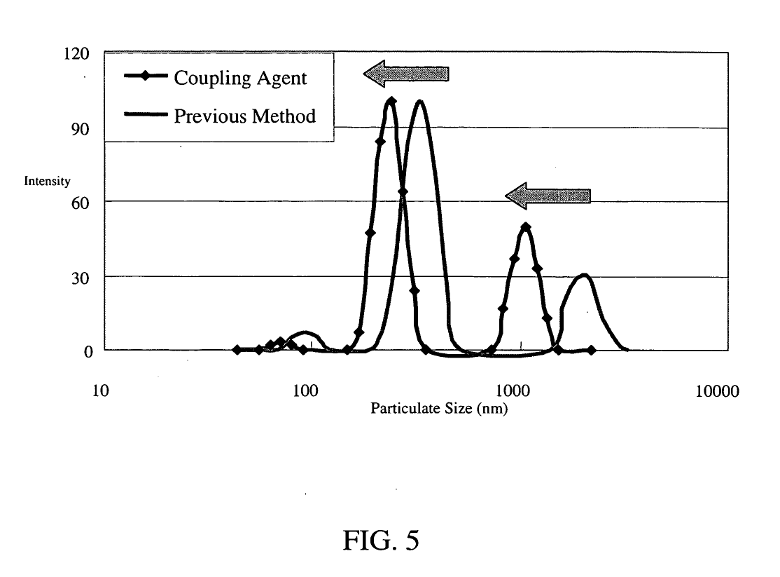

Referring to FIG. 5, when the solvent is water, it is found that the comparison between the pastes of adding a coupling agent and not adding a couple agent of previous method, the results show that the values deviate from greater particulate sizes to smaller particulate sizes because the coupling agent becomes evenly dispersed after the coupling agent is bonded to the catalyst, thereby making the distributed particulate sizes smaller than those with no coupling agent in the previous method. For the catalyst with no coupling agent added in the previous method, the particulates aggregate, thereby increasing the particulate sizes. This suggests that the addition of a coupling agent in the present invention can truly disperse the catalyst evenly, thereby increasing the exposed active surface area of the catalyst in order to increase the acting surface area.

### Example 4

### Half-Cell Testing

The PtRu black anode paste treated according to Example 1 is fabricated into an anode and then a half-cell oxidation test is performed in 10% MeOH and 0.5M H₂SO₄ at 40° C.

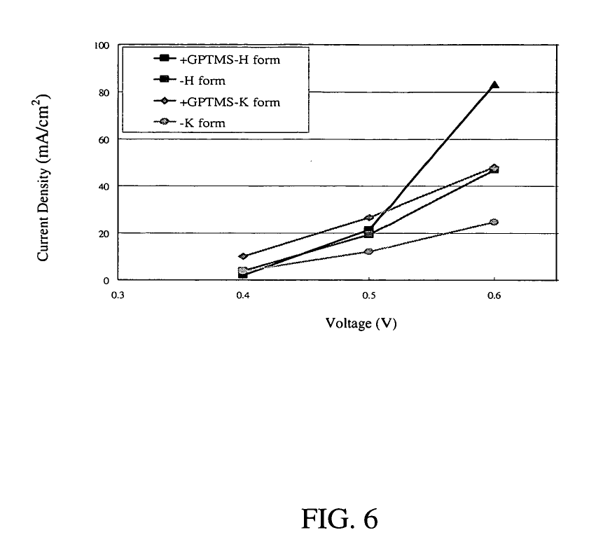

Referring to FIG. 6 for the experimental results, it is found that when the voltage is at 0.6 V, the current density at GPTMS-H form electrode is increased in approximately 60%, whereas the GPTMS-K form electrode is increased in approximately 50%, if making a comparison between the anode paste with GPTMS added and the anode paste without GPTMS added. The results show that the addition of a coupling agent can truly enhance the utilization of catalysts, thereby enhancing the efficiency of fuel cells.

### Example 5

### Full-Cell Testing

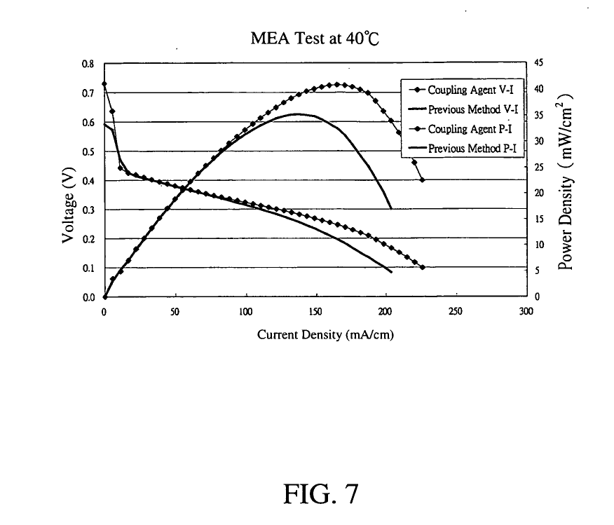

Perform a polarization testing of the MEA fabricated in Example 1 at 10% MeOH and in the air. Experimental results are shown in FIG. 7.

Referring to FIG. 7 for the coupling agent P-I relationship of the MEA (anode catalyst amount used: PtRu 3.3mg/cm²; cathode catalyst amount used: PtRu 4.2 mg/cm²) fabricated from the paste with the coupling agent added, it is found that the max power density at 40° C. is approximately 41 mW/cm², but the max power density is only 35 W/cm² for the Previous Method P-I relationship of the MEA (anode catalyst amount used: PtRu 3.8 mg/cm; cathode catalyst amount used: PtRu 4.3 mg/cm²) fabricated from the conventional catalyst paste without the coupling agent added. The results clearly show that the catalyst paste of the present invention can achieve higher discharge efficiency with a smaller amount of catalysts, if compared with the amount of catalysts used for the conventional fuel cell.

### Example 6

### Catalyst Utilization Testing

A Pt black cathode paste is treated according to Example 1 and fabricated into a cathode, which is hot pressed with the anode and Nafion® 112 to form a MEA. When hydrogen gas is passed to the anode and nitrogen gas is passed to the cathode at 40° C., cyclic voltammetry (CV) is performed. Then the utilization of catalysts is calculated by the following formula:

$$Utilization = \frac{Q ( \frac{mC}{{cm}^{2}} )}{\begin{matrix}0.22 ( \frac{mC}{{cm}^{2}} ) \times \\ CatalystLoading ( \frac{mg}{{cm}^{2}} ) \times \\ CO - BET ( \frac{{cm}^{2}}{mg} )\end{matrix}} \times 100 \%$$

where Q is calculated from the H⁺ desorption area, 0.22 mC/cm²is a theoretical value that needed to produce a monolayer adsorbed H⁺ on polycrystalline Pt, and the specific surface density is determined by CO chemi-sorption. Experimental results are shown in Table 1. When the scan rate is 20 mV/sec, results show that the utilization of the catalyst not treated by the composition of the present invention is only 47.712% whereas the utilization of the catalyst treated by the composition of the present invention reaches 54.855%. About 15% utilization increase can be achieved in this case. The results prove that the utilization of the catalyst treated by the composition of the present invention is significantly enhanced.

TABLE 1
Catalyst Utilization of the MEA

Catalyst Utilization of the MEA (%)

| | 5 mV/sec | 10 mV/sec | 20 mV/sec |
|---|---|---|---|
| Surface not treated | 48.116 | 49.33 | 47.712 |
| by the present | | | |
| invention | | | |
| Surface treated by | 51.329 | — | 54.855 |
| the present invention | | | |

In summary, the coupling agent added to the composition according to the present invention can truly enhance the absorption and even dispersion of the polymer and the catalyst. On the one hand, the method of the present invention can treat the catalyst surface by adding a coupling agent in order to form stable spatial repulsion, thereby avoiding the aggregation of catalyst particles. On the other hand, no matter whether the catalyst particles are dispersed or aggregated, they can become efficient catalysts, thereby enhancing the utilization of catalysts and lowering the production costs of fuel cell. Moreover, the present invention is characterized by having dispersion not affected by coating/drying, further reducing the amount of PFSI used for the catalyst layer, thereby reducing the production cost of fuel cells. Furthermore, the present invention can enhance the effective active area per unit volume of the catalyst, thereby facilitating the depletion of methanol (in the anode) and resisting the effects (on the cathode) caused by the mixing of methanol. The present invention can also avoid the growth of particles in the reaction by means of fixed catalyst particles (whether a catalyst carrier is used or not.)

It is to be understood that the foregoing description of the present invention should not be based to restrict the invention, and that all equivalent modifications and variations made without departing from the intent and import of the foregoing description should be included in the following claim.

What is claimed is:

1. A complex for enhancing the utilization of catalysts in fuel cells, comprising: catalysts, coupling agents, and proton-exchanged ionic polymers, wherein said coupling agents are bonded to said catalysts by a B1 functional group and bonded to said proton-exchanged ionic polymers by a B2 functional group in order to form a complex.

2. The complex for enhancing the utilization of catalysts in fuel cells of claim 1, wherein said B1 functional group includes the silyl group, the silane group, the carbonate group, the phosphate group, or the borate group.

3. The complex for enhancing the utilization of catalysts in fuel cells of claim 1, wherein said B2 functional group includes the epoxy group or the amino group.

4. The complex for enhancing the utilization of catalysts in fuel cells of claim 1, wherein said coupling agents are 3-glycidoxypropyl trimethoxysilane (GPTMS) or 3-aminopropyl trimethoxysilane (APTMS).

5. The complex for enhancing the utilization of catalysts in fuel cells of claim 1, wherein said catalysts are transition metals or compounds thereof.

6. The complex for enhancing the utilization of catalysts in fuel cells of claim 5, wherein said catalysts are PtRu or Pt.

7. The complex for enhancing the utilization of catalysts in fuel cells of claim 1, wherein said catalyst can further be bonded to a catalyst carrier, and said carrier is bonded to said proton-exchanged ionic polymers.

8. The complex for enhancing the utilization of catalysts in fuel cells of claim 7, wherein said catalyst carrier includes carbon, titanium, gold, silver, or copper.

9. The complex for enhancing the utilization of catalysts in fuel cells of claim 1, wherein said proton-exchanged ionic polymer is a perfluoro polymer.

10. The complex for enhancing the utilization of catalysts in fuel cells of claim 9, wherein said perfluoro polymer is PSFI or Nafion®.

11. The complex for enhancing the utilization of catalysts in fuel cells of claim 1, wherein a method for bonding is a covalent bonding or a non-covalent bonding.

12. A composition for enhancing the utilization of catalysts in fuel cells, comprising:
catalysts;
proton-exchanged ionic polymers; and
coupling agents;
wherein the weight ratio of said catalysts to said proton-exchanged ionic polymers is 0.1-100, and the weight ratio of said catalysts to said coupling agents is 10-1000; wherein said coupling agents are bonded to said catalysts by a B1 functional group and bonded to said proton-exchanged ionic polymers by a B2 functional group to form a complex.

13. The composition for enhancing the utilization of catalysts in fuel cells of claim 12, wherein said B1 functional group includes the silyl group, the silane group, the carbonate group, the phosphate group, or the borate group.

14. The composition for enhancing the utilization of catalysts in fuel cells of claim 12, wherein said B2 functional group includes the epoxy group or the amino group.

15. The composition for enhancing the utilization of catalysts in fuel cells of claim 12, wherein said coupling agents are 3-glycidoxypropyl trimethoxysilane (GPTMS) or 3-aminopropyl trimethoxysilane (APTMS).

16. The composition for enhancing the utilization of catalysts in fuel cells of claim 12, wherein said catalysts are transition metals or compounds thereof.

17. The composition for enhancing the utilization of catalysts in fuel cells of claim 16, wherein said catalysts are PtRu or Pt.

18. The composition for enhancing the utilization of catalysts in fuel cells of claim 12, wherein said catalysts can further be bonded to a catalyst carrier, and said catalyst carrier is bonded to said proton-exchanged ionic polymers.

19. The composition for enhancing the utilization of catalysts in fuel cells of claim 18, wherein said catalyst carrier includes carbon, titanium, gold, silver, or copper.

20. The composition for enhancing the utilization of catalysts in fuel cells of claim 12, wherein said proton-exchanged ionic polymer is a perfluoro polymer.

21. The composition for enhancing the utilization of catalysts in fuel cells of claim 20, wherein said perfluoro polymer is PSFI or Nafion®.

22. The composition for enhancing the utilization of catalysts in fuel cells of claim 12, wherein a method for bonding is a covalent bonding or a non-covalent bonding.

23. The composition for enhancing the utilization of catalysts in fuel cells of claim 12, wherein the weight ratio of said catalysts to said coupling agents is 10-200.

24. The composition for enhancing the utilization of catalysts in fuel cells of claim 12, wherein the weight ratio of said catalysts to said proton-exchanged ionic polymers is 1-20.

25. The composition for enhancing the utilization of catalysts in fuel cells of claim 12, wherein said composition further comprises a solvent.

26. The composition for enhancing the utilization of catalysts in fuel cells of claim 25, wherein said solvent is n-butyl acetate (nBA), ethyleneglycol (EG), or glycerol.

27. A method for enhancing the utilization of catalysts in fuel cells, comprising the steps of:
(a) utrasonicating catalysts in solvent;
(b) adding coupling agents to bond to said catalysts; and
(c) adding a perfluoro polymer to bond to said coupling agent and form a catalyst-coupling agent-perfluoro polymer complex whereby developing a stable dispersion;
wherein said coupling agents of step (b) are bonded to said catalyst by a B1 functional group and bonded to said perfluoro polymer by a B2 functional group.

28. The method for enhancing the utilization of catalysts in fuel cells of claim 27, further comprise adding an oxidizing agent to oxidize a surface of said catalysts before step (b).

29. The method for enhancing the utilization of catalysts in fuel cells of claim 27, wherein said B1 functional group includes the silyl group, the silane group, the carbonate group, the phosphate group, or the borate group.

30. The method for enhancing the utilization of catalysts in fuel cells of claim 27, wherein said B2 functional group includes the epoxy group or the amino group.

31. The method for enhancing the utilization of catalysts in fuel cells of claim 27, wherein said coupling agents of step (b) are 3-glycidoxypropyl trimethoxysilane (GPTMS) or 3-aminopropyl trimethoxysilane (APTMS).

32. The method for enhancing the utilization of catalysts in fuel cells of claim 27, wherein said catalysts of step (a) are transition metals or compounds thereof.

33. The method for enhancing the utilization of catalysts in fuel cells of claim 32, wherein said catalysts of step (a) are PtRu or Pt.

34. The method for enhancing the utilization of catalysts in fuel cells of claim 27, wherein said catalysts of step (a) can further be bonded to a catalyst carrier, and said catalyst is bonded to a proton-exchanged ionic polymer.

35. The method for enhancing the utilization of catalysts in fuel cells of claim 34, wherein said catalyst carrier of step (a) includes carbon, titanium, gold, silver, or copper.

36. The method for enhancing the utilization of catalysts in fuel cells of claim 27, wherein said perfluoro polymer of step (c) is PSFI or Nafion®.

37. The method for enhancing the utilization of catalysts in fuel cells of claim 27, wherein a method for bonding is a covalent bonding or a non-covalent bonding.

38. The method for enhancing the utilization of catalysts in fuel cells of claim 27, wherein the weight ratio of said catalysts to said coupling agents is 10-1000.

39. The method for enhancing the utilization of catalysts in fuel cells of claim 27, wherein the weight ratio of said catalysts to said proton-exchanged ionic polymers is 0.1-100.
